(19) United States
(12) Patent Application Publication
(10) Pub. No.: US 2006/0112858 A1
(43) Pub. Date: Jun. 1, 2006

(54) Liquid nano carbon and application products

(75) Inventor: Khe C. Nguyen, Ho Chi Minh City (VN)

Correspondence Address: TRAN & ASSOCIATES, 6768 MEADOW VISTA CT., SAN JOSE, CA, 95135, US

(73) Assignee: Saigon Hi Tech Park, Ho Chi Minh City (VN)

(21) Appl. No.: 10/987,949

(22) Filed: Nov. 12, 2004

(51) Int. Cl. C09C 1/44

(52) U.S. Cl. 106/472

(57) ABSTRACT

A process for making liquid nano carbon includes: pretreating raw materials by heat; attaching the electrolytic chemical groups onto the surface of heat pretreated carbon powder; and isolating nano particles in an electrolytic environment. The resulting fabricated particle includes liquid nano carbons having particles with an average size less than 30 nanometers.

### BACKGROUND

The present invention relates to liquid nano-carbons to produce nano-scale patterns in integrated circuit devices and for digital/analog printing to produce hard copy.

Lithography is a process used for high-volume production of devices such as integrated circuits and flat-panel displays, among others. A popular technology for high-volume production is optical lithography because it can achieve a high throughput via the parallel nature of its pattern generation where a large number of features are simultaneously printed onto a substrate during a single exposure. In conventional analog photolithography systems, the photographic equipment requires a mask for printing an image onto a subject. The subject may include, for example, a photo resist coated semiconductor substrate for manufacture of integrated circuits, metal substrate for etched lead frame manufacture, conductive plate for printed circuit board manufacture, or the like. A patterned mask or photo mask may include, for example, a plurality of lines or structures. During a photolithographic exposure, the subject must be aligned to the mask very accurately using mechanical control with sophisticated alignment.

Conventional photolithography in wafer processing using a mask and a mask aligner can produce ICs with a feature size larger than 0.1 micron (100 nm). However, conventional systems are challenged when used to produce ICs with a feature size smaller than 0.1 micron. For example, the exposure system to provide short wavelength in the range of extreme UV is expensive, and the photo resist materials which exhibits high contrast at that wavelength range. In this case, the masking lithographic systems which does not need light is a better choice than the traditional photolithography in certain situations. Direct writing process using laser, X-ray, electron beam, ion beam, molecular beam, dip-pen lithography, nanoimprint, nanomolding have been known to produce sub micron and nano scale patterns as reviewed by G. M, Whitesides et al in Scientific American, September 2001, page 39.

The reactivity of diazonium salts with aromatic compounds such as coals has been reported in “The Reaction of Diazonium Salts with Humic Acids and Coals: Evidence for Activated Methylene Bridges in Coals and Humic Acids” Fuel 43 (4) at pp. 289-298 (1964) or in Chapter 11 of Advanced Organic Chemistry book edited by Francis A. Carey and Richard J. Sunberg, 4^{th} Edition, published in 2003 by Kluwer Academic/Plenum Publishers. U.S. Pat. Nos. 5,554,739 and 6,494,946 disclose chemical modifications of the surface of a carbon black powder by diazo-coupling of specific functional groups, yielding stable aqueous dispersion of carbon particle and average particle size in aqueous environment of about 100-150 nm. U.S. Pat. Nos. 4,390,608; 4,391,889 and 4,504,560 also disclosed the diazo coupling reaction onto phenyl ring at the adjacent of hydroxyl —OH, forming bisazo pigment having electrical conduction properties.

### SUMMARY

In one aspect, a fabricated particle includes a “liquid” nano carbon having individual particles with an average size less than 30 nanometers, each particle having a solid carbon based core and a shell made with one or more anchor groups chemically attached to the shell.

In another aspect, a process of making the “liquid” nano carbon includes: pretreating raw materials by heat; attaching the electrolytic chemical groups onto the surface of heat pretreated carbon powder; and isolating nano particles in an electrolytic environment (through solvents and electrolytic additives, for example).

In yet another aspect, an anchor group is formed by doping a surface of a raw material with a metal transition catalyst; soaking the catalyst doped raw material in a proton source and/or a hydroxyl source agent having a carbon based core; baking the carbon based core at 600 C-1000 C followed by quick water quenching prior to chemical attachment of the anchor group; and attaching the anchor group onto the surface of the carbon based core to form a shell, wherein the anchor groups forming the shell of the carbon based core comprise electrolytic chemical groups which can form charge for the liquid nano carbon in an electrolytic environment.

Implementations of the above aspect may include one or more of the following. The anchor groups can be water soluble ionic groups and/or non ionic groups. The anchor groups can be organic solvent soluble chemical functional groups including but not limited to alkyl, alkenes, phenyl alkyl, aryl, aryl alkyl, perfluoroalkyl, cyclobutane, siloxane, —SiH, —SiCH═CH2, with and without —OH, —SH, —COOH, —COOR, —CO, —CHO, —NO2, —NR1R2, —OR, —SR, —CN, —SO2, halogen (—Cl, —I, —Br, —F), in which R, R1, R2═H, alkyl, alkenes, phenyl alkyl, aryl, aryl alkyl, perfluoroalkyl, cyclobutane, siloxane, —SiH, —SiCH═CH2.

The ink made out of liquid nano carbon can be used for nanolithography including dip pen lithography, nanoimprint, x-ray lithography, e-beam lithography or any print heads having capabilities of producing nano patterning. The ink made out of liquid nano carbon can be used for both digital and analog printing process. The ink made out of liquid nano carbon can be used as dry and liquid toner for electro photographic printing apparatus. The ink made out of liquid nano carbon can also be used as drop on demand ink and continuous ink for thermal inkjet print head and piezoelectric inkjet print head. The ink made out of liquid nano carbon can be used as inking materials for thermography including direct thermal printing, thermal transfer printing. The ink made out of liquid nano carbon can be printed on image receiver comprising of semiconductor wafer, insulator and insulating wafer, plastics, metal, polymer, plain paper and coated paper, cellulose fabrics. The liquid nano carbon can be used alone or in a combination with polymers, low molecular weight additives, pigment colorants, dye colorants, charge control agents, ion charge neutralizers. The liquid nano carbon can be used to form micro pattering in combination with photo resist utilized in photolithography. Masking lithography using liquid nano carbon can be used as etch mask for deep RIE. The liquid nano carbon can be used as electrode and/or proton exchange membrane for fuel cell, among others.

Advantages of the liquid nano ink may include one or more of the following. The liquid nano carbon product having the following characteristics:
a) Average particle size is smaller than 30 nm
b) Well stable in variety of hydrophilic and hydrophobic solvents
c) Form uniform thin film by various coating process without using vacuum technology
d) Capable of forming micro patterns with conventional photolithography
e) Capable of forming ink and recording media for digital and analog printing to produce nano scale patterns, high resolution hard copy

The liquid nano carbon particles having particle size less than 30 nm is accessible through multiple diazo coupling reaction of electrolytic functional groups onto carbon powder which has been heat treated prior to the coupling reaction. The product can be used for nanolithography and digital printing materials. Micro-patterns can also be formed on the product in combination with photo-resist and photolithography.

The printing inks and printing media can produce nano scale patterns with various nano scale print head technologies. For example, the liquid nano carbon particles can wet the surface of a template created by nano-imprinting and/or nano-molding techniques and then transferred to a target wafer. Depending on chemical functional groups attached on the surface, the liquid nano carbon ink can be compatible with either hydrophilic surface or hydrophobic surface of the template. If the ink particles are larger than the cross sectional size of the nano scale print head, then the inking process as well as the image transfer process will not successfully reach the target of nano scale patterning operation.

Applications of the liquid nano carbon can be found in the printing media, for example, the printing media of e-beam and X-Ray writing heads. In this case, the liquid nano carbon particles are dispersed in coating components including solvents and polymeric binders with or without surfactants. The coating media containing “liquid’ nano carbon can simply be spin-coated on a substrate and soft baked to remove a coating solvent residue to form a medium ready for printing with a high energy beam print head such as an e-beam or X-Ray print head. The liquid nano carbon particle it self, can be converted from a “hydrophilic state” into a “hydrophobic state” when being exposed to one or more high energy sources such as but not limited to e-beams or X-Rays. In one embodiment, the area exposed to the high energy beam remains on the substrate while the unexposed hydrophilic area can be washed away with an aqueous developer, leaving the desired image on the substrate.

In combination with heat-induced solubility change binders, the liquid nano particles work as a heat absorbing sensitizer. The absorbed heat energy can be transferred into the adjacent binder to cause the solubility change of the binder, for example, from solubility into the dissolving and versa. One example of liquid nano carbon particle as heat sensitizer can be found from a mixture of hydrophilic liquid nano carbon particle with heat induced hydrogen bonding former molecules such as polyaminoacids found in protein, egg albumin, among others. A dry film composed of a mixture of hydrophilic liquid nano carbon and egg albumin renders solidified matter when exposed to heat mode laser, e-beam or X-Ray print head while unexposed area stays aqueous soluble. A solid film composed of mixture of hydrophilic liquid nano carbon particles and gelatin, reversely, can be hot melted by excimer laser, CO2 laser, e-beam, X-Ray and renders positive visible image under aqueous developer.

Ultra small particle size of the liquid nano carbon is useful for high resolution and highly smooth hard copy or printout from printers such as laser printers, inkjet printers and thermal printers. The average particle size of conventional dry toner for laser printer is ranging between 3-5um. The average particle size of conventional liquid toner for laser printer ranges between 0.8-1um. These toner technologies need colorant, adhesive binder and charge control agent. Using liquid nano carbon simplify the process of making toner and also enhance the electrostatic stability of toner particle as the charge induced functional groups are chemically bonded onto the surface of liquid carbon nano particles. As liquid carbon nano particles are highly stable, a super stable liquid toner having nano scale particle size can be formed easily without heavy mechanical stirring power. By the same token, a dry toner can be formed by removing fluid carrier from liquid toner.

In inkjet printing applications, liquid nano carbon particles can be used in thermal inkjet and piezoelectric inkjet print heads. Furthermore, liquid nano carbon particles with suitable anchor groups can be used either in water base or oil base ink.

In thermal printing applications, liquid nano carbon can be used for direct thermal printing or indirect thermal transfer printing ribbon or solid phase change ink (hot melt ink), among others.

### BRIEF DESCRIPTION OF THE DRAWINGS

FIGS. 1A-1B show exemplary processes for forming a printing ink with liquid nano carbon particles.

FIG. 2 shows an AFM (Atomic Force Microscopy) image of liquid nano carbon particles electrolyzed in water.

FIG. 3A shows a SEM (Scanning Electron Microscope) image of the raw material.

FIG. 3B exhibits the liquid nano carbon, electrolyzed in water.

FIG. 3C exhibits liquid nano carbon in water added with electrolytic molecule.

FIG. 4 exhibits micropatternings on “liquid “nano carbon film using conventional positive photo resist.

### DESCRIPTION

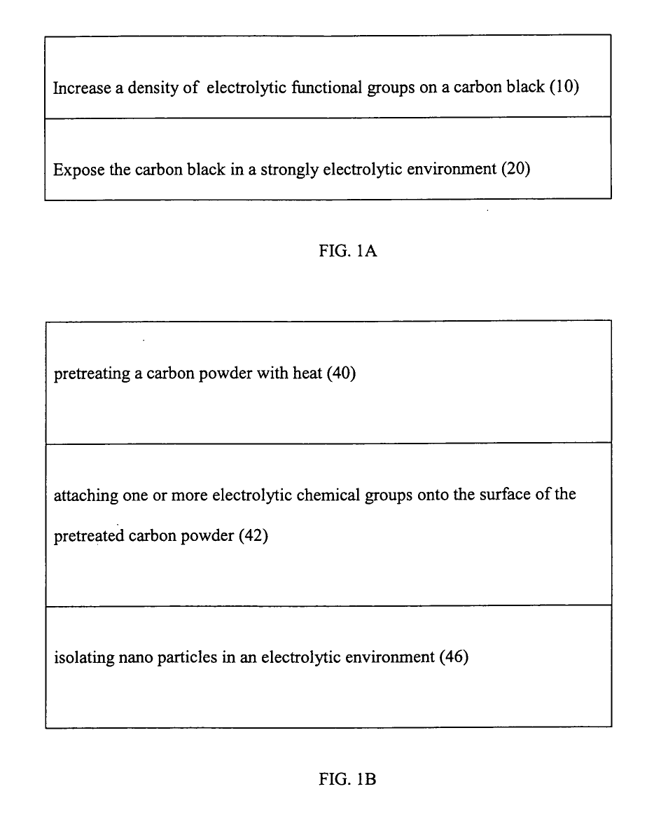

FIG. 1A shows an exemplary process for forming a printing ink with liquid nano carbon particles. This is done by increasing a density of electrolytic functional groups on a carbon black (10); and exposing the carbon black in a strongly electrolytic environment (20). Operation 10 chemically attaches electrolytic groups onto the surface of a carbon powder, while operation 20 provides the electrolytic environment which electrolyzes the individual carbon particles into charged particles and the charged particles repel each other to form smaller aggregate and automatically isolate themselves into nano particles.

FIG. 1B shows a second exemplary process for forming liquid carbon particles by pretreating a carbon powder with heat (40); attaching one or more electrolytic chemical groups onto the surface of the pretreated carbon powder (42); and isolating nano particles in an electrolytic environment (46).

Besides the electrolytic environment which acts as the main precursor for particle isolation, a hydrophobic fluid can be used to enhance the particle separation and to maximally isolate against aggregation as well as flocculation. The particles formed are called liquid nano-carbons and the nano scale carbon particles can be used for the various applications discussed above.

The electrolytic functional groups can be chemical groups which exhibit strong electrolytic properties under electrolytic solvents, electrolytic additives and electrolytic environment such as electrically biased environment. In the electrolytic environment, the chemical functional groups become charged particles and repel each other due to an electrostatic repulsive force applied to particles having the same charge. The electrolytic chemical groups attached to carbon particles are dispersed in electrolytic solvents, resulting in much smaller size particles. The small-sized carbon particles thus have a high solubility when the original carbon powder into the electrolytic solvents. The resulting product is liquid nano carbons—a type of carbon which can be dispersed in the liquid due to the compatibility of anchor groups on the individual carbon particles with a surrounding fluid such as liquid or gas. In one example using water, the electrolytic groups on carbon powder surface are ionized into charged species. This ionization can also occur in polar solvents or in non-polar solvents added with polar additives. The polar solvents and polar additives act as electrolytic molecules which can ionize or polarize the electrolytic groups on carbon powder to form charged carbon particles.

More details on the liquid nano carbon fabrication process is disclosed in commonly-owned co-pending application Ser. No. 10/843,411 filed on May 10, 2004 and entitled “MASKLESS LITHOGRAPHY USING UV ABSORBING NANO PARTICLE”, the content of which is hereby incorporated by reference. More details on the liquid nano particle print head is disclosed in commonly-owned co-pending application Ser. No. 10/______ filed on Nov. 12, 2004 and entitled “CNT PRINT HEAD ARRAY”, the content of which is hereby incorporated by reference.

The raw materials of liquid nano carbon are selected from variety sources including natural coal products such as mud coals embedded in the rice field, fossil coals or charcoal from oil wells, coal tar and man made coals product from oxygen free burning process of coconut, pine wood, wood. The raw materials can also be obtained from a burning process with kerosene oil, diesel, rubber, unsaturated natural gas. The commercially available carbon black products from Cabot, Degussa have also been used.

The bulky block coal products need to be pulverized into powdery products using certain kinds of mechanical grinding mechanism including high speed attritor. The powdery coals, then, are purified with hot water without and with acidic or base additives to remove mineral impurities. The organic impurities are removed off the raw materials with organic solvents following the basic steps of organic chemical experiments.

To form targeted liquid nano carbon, after being purified following the above described process, the raw materials of any source should go through a heat treatment to enhance their susceptibility with the diazo-coupling process and to reach the desirable nano particle size in the range below 20 nm.

The heat treatment can be done in the air but it is more preferred in oxygen free environment by filling up the bake oven with fast circulating nitrogen gas. The heat treatment temperature is in the wide range between 200 C up to 700 C followed up with a fast quench of steam vapor. The heat treatment time can varied between 30 sec up to 60 minutes per gram of the raw materials and enhances the yield of liquid nano carbon particles.

The carbon black prepared by oil burning process in a furnace equipped with water quenching mechanism exhibits primary aggregate having average particle size ranging between 75-100 nm and up depending on fabrication process. These carbon powders exhibit hydrophobicity.

In one implementation, electrolytic chemical groups can be selected and chemically attached to the surface of the carbon powder to form liquid nano carbon through diazo coupling reactions as discussed in U.S. Pat. Nos. 4,390,608; 4,391,889; 4,504,560; 5,554,739 and 6,494,946. Electrolytic chemicals can be found from a group of acid or base or amine or any intermediates which can convert into acid and/or amine salts to form charged in electrolytic environment including polar fluids and electrically biased environment. The examples of electrolytic chemical groups are but not limited to carboxylic acid and carboxylic acid salts, sulfonic acid and sulfonic acid salts, ammonium salts, quaternary ammonium salts, carbonium salts, iodonium salts, pyrrilium salts, sulfonium salts, phosphonium salts, squarylium salts, pyridinium salts, the salts of acrylic acid; methacrylic acid; chloromethacrylic acid; maleic acid; allylamine; N,N-diethylallylamine; vinyl sulfonamide; sodium acrylate; sodium methacrylate; ammonium acrylate; ammonium methacrylate; acrylamidopropanetriethylammonium chloride; methacrylamidopropanetriethylammonium chloride; vinyl-pyridine hydrochloride; sodium vinyl phosphonate and sodium 1-methylvinylphosphonate; sodium vinyl sulfonate; sodium 1-methylvinyl-sulfonate; sodium styrenesulfonate; sodium acrylamidopropanesulfonate; sodium methacrylamidopropanesulfonate; and sodium vinyl morpholine sulfonate . . . and the likes. These are main anchor groups forming electrolytic properties of the carbon particles.

Additionally, subordinate anchor groups can be chemically attached to the surface of “liquid” nano carbon together with the main anchor(s) to improve the particle separation in various type of solvents for various applications of the liquid nano carbon as follows:
One subordinate anchor groups can be selected among non ionic and water soluble chemistry such as hydroxyl —OH rich ethylene glycol, propylene glycol, ethylene and propylene oxide, pyrrolidone, maleimide; N-phenyl maleimide; N-hexyl maleimide; N-vinyl-phthalimide; and N-vinyl maleimide, imidazole; acrylamide; N,N-dimethyl methacrylamide; aryloxy piperidine; and the likes.
Another subordinate anchor group can be selected among lipophilic chemistry which can be well soluble in polar and non polar solvents such as halogen, alkyl, aryl, alkoxyl, substituted alkyl, aryl or alkoxyl, perfluoroalkyl, cyclobutane, siloxane, —SiH, —SiCH═CH2, with and without —OH, —SH, —COOH, —COOR, —CO, —CHO, —NO2, —NR1R2, —OR, —SR, —CN, —SO2, halogen (—Cl, —I, —Br, —F), ethyl acrylate; ethyl methacrylate; benzyl acrylate; benzyl methacrylate; propyl acrylate; propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicycopentyl ether acrylate; vinyl ethyl ketone; vinyl propyl ketone; vinyl hexyl ketone; vinyl octyl ketone; vinyl butyl ketone; cyclohexyl acrylate; 3-methacryloxypropyldimethylmethoxysilane; 3-methacryloxypropylmethyldimethoxysilane; 3-methacryloxypropylpentamethyldisiloxane; 3-methacryloxypropyltris(trimethylsiloxy)silane; 3-acryloxypropyldimethylmethoxysilane; acryloxypropylmethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; isobutyl acrylate; isobutyl methacrylate; 2-ethylhexyl acrylate; 2-ethylhexyl methacrylate; isooctyl acrylate; isooctyl methacrylate; N,N-dihexyl acrylamide; N,N-dioctyl acrylamide; aminoethyl acrylate; aminopropyl acrylate; aminopropyl methacrylate; aminoisopropyl acrylate; aminoisopropyl methacrylate; aminobutyl acrylate; aminobutyl methacrylate; aminohexyl acrylate; amimohexyl methacrylate; aminooctadecyl methacrylate; aminooctadecyl acrylate; aminolauryl methacrylate; aminolauryl acrylate; N,N-dimethylaminoethyl acrylate; N,N-dimethylaminoethyl methacrylate; N,N-diethylaminoethyl acrylate; N,N-diethylaminoethyl methacrylate; piperidino-N-ethyl acrylate; vinyl propionate; vinyl acetate; vinyl butyrate; vinyl butyl ether; and vinyl propyl ether, among others.

Electrolytic solvents are strong polar solvents which can provoke the ionization of the electrolytic groups attached to the liquid nano carbon. Electrolytic solvents can also form a dipole momentum with electrolytic chemical groups onto the surface of “liquid” nano carbon. Examples of electrolytic solvents include water, alcohols and polyols (such as butanol, butanediol, butanetriol, phenol, for example), ketones, halogenated solvents, pyrrolidones, morpholines, quinolines, acetic acid, among others. Electrolytic additives are basically acidic or alkaline/basic functional molecules including low molecular weight compounds and high molecular weight polymers. The examples of electrolytic additives are but not limited to NaOH, KOH, Zn(OH)2, Mg(OH)2, NH4OH, NaHCO3, NaHSO3, MeONa, MeOK, EtONa, EtOK, aminotoluene sulfonic acid, 2-amino-1-propanol, among others.

Dependent upon the applications, the liquid nano carbon can be used alone in electrolytic solvents with and without electrolytic additives or it can be used with polymer. The suitable polymers for thermo sensitive recording media with high energy source print heads( e-beam, laser beam, X-Ray, thermal print heads, . . . ) are heat induced hydrogen bonding formers such as but not limited to egg albumin, heat induced hydrogen bonding deformers such as but not limited to gelatin, oceanic protein and the likes, heat induced degradation such as but not limited to polymethylmethacrylate (PMMA), polyimides, among others.

In one exemplary implementation, raw materials forming liquid nano carbon, which are any kinds of coals including carbon black are pretreated with heat. The heat treatment can occur at the temperature range from 150 C up to 800 C in the open air or in the nitrogen filled environment. The heat treatment can be done with catalysts such as transition metals including but not limited to Pt, Mo, Ni, Co, Fe, Ni, in the presence of proton supply agents such as hydrogen gas, methanol, and ethanol The heat pretreatment is carried out in a certain time range, followed with a water quenching. The heat treatment time can varied between 30 sec up to 60 minutes per gram of the raw materials. It is not well understood at this point in time the role of heat treatment step prior to the step of forming liquid nano carbon yet. However, it is needed to affect the yield of liquid nano carbon. Without the heat treatment, the diazo coupling products have never gone down to desirable nano particle size in the range below 30 nm, rather than staying in an aggregate form having average particle size in the range 100-150 nm. The chemical attachment of the electrolytic groups on the pretreated raw materials can be done through diazo coupling reaction as already cited above. The electrolytic chemical groups can be found from a group of acid or base or amine or any intermediates which can convert into acid and/or amine salts to form charge in electrolytic environment including polar fluids and electrically biased environment. The examples of electrolytic chemical groups are but not limited to carboxylic acid and carboxylic acid salts, sulfonic acid and sulfonic acid salts, ammonium salts, quaternary ammonium salts, carbonium salts, iodonium salts, pyrrilium salts, sulfonium salts, phosphonium salts, squarylium salts, pyridinium salts, the salts of acrylic acid; methacrylic acid; chloromethacrylic acid; maleic acid; allylamine; N,N-diethylallylamine; vinyl sulfonamide; sodium acrylate; sodium methacrylate; ammonium acrylate; ammonium methacrylate; acrylamidopropanetriethylammonium chloride; methacrylamidopropanetriethylammonium chloride; vinyl-pyridine hydrochloride; sodium vinyl phosphonate and sodium 1-methylvinylphosphonate; sodium vinyl sulfonate; sodium 1-methylvinyl-sulfonate; sodium styrenesulfonate; sodium acrylamidopropanesulfonate; sodium methacrylamidopropanesulfonate; and sodium vinyl morpholine sulfonate . . . And the likes. These are main anchor groups forming electrolytic properties of the liquid nano carbon particles. There are also subordinate anchor groups which can be chemically attached to the surface of “liquid “nano carbon together with the main anchor(s) to improve the particle separation in various types of solvents for various applications of the liquid nano carbon. The first subordinate anchor groups are selected among non ionic and water soluble chemistry such as hydroxyl —OH rich ethylene glycol, propylene glycol, ethylene and propylene oxide, pyrrolidone, maleimide; N-phenyl maleimide; N-hexyl maleimide; N-vinyl-phthalimide; and N-vinyl maleimide, imidazole; acrylamide; N,N-dimethyl methacrylamide; aryloxy piperidine; and the likes. The second subordinate anchor groups are selected among lipophilic chemistry which can be well soluble in polar and non polar solvents such as halogen, alkyl, aryl, alkoxyl, substituted alkyl, aryl or alkoxyl, perfluoroalkyl, cyclobutane, siloxane, —SiH, —SiCH═CH2, with and without —OH, —SH, —COOH, —COOR, —CO, —CHO, —NO2, —NR1R2, —OR, —SR, —CN, —SO2, halogen (—Cl, —I, —Br, —F), ethyl acrylate; ethyl methacrylate; benzyl acrylate; benzyl methacrylate; propyl acrylate; propyl methacrylate; iso-propyl acrylate; iso-propyl methacrylate; butyl acrylate; butyl methacrylate; hexyl acrylate; hexyl methacrylate; octadecyl methacrylate; octadecyl acrylate; lauryl methacrylate; lauryl acrylate; hydroxyethyl acrylate; hydroxyethyl methacrylate; hydroxyhexyl acrylate; hydroxyhexyl methacrylate; hydroxyoctadecyl acrylate; hydroxyoctadecyl methacrylate; hydroxylauryl methacrylate; hydroxylauryl acrylate; phenethyl acrylate; phenethyl methacrylate; 6-phenylhexyl acrylate; 6-phenylhexyl methacrylate; phenyllauryl acrylate; phenyllauryl methacrylate; 3-nitrophenyl-6-hexyl methacrylate; 3-nitrophenyl-18-octadecyl acrylate; ethyleneglycol dicycopentyl ether acrylate; vinyl ethyl ketone; vinyl propyl ketone; vinyl hexyl ketone; vinyl octyl ketone; vinyl butyl ketone; cyclohexyl acrylate; 3-methacryloxypropyl-dimethylmethoxysilane; 3-methacryloxypropylmethyldimethoxysilane; 3-methacryloxypropylpentamethyldisiloxane; 3-methacryloxypropyltris(trimethylsiloxy)silane; 3-acryloxypropyldimethylmethoxysilane; acryloxypropylmethyldimethoxysilane; trifluoromethyl styrene; trifluoromethyl acrylate; trifluoromethyl methacrylate; tetrafluoropropyl acrylate; tetrafluoropropyl methacrylate; heptafluorobutyl methacrylate; isobutyl acrylate; isobutyl methacrylate; 2-ethylhexyl acrylate; 2-ethylhexyl methacrylate; isooctyl acrylate; isooctyl methacrylate; N,N-dihexyl acrylamide; N,N-dioctyl acrylamide; aminoethyl acrylate; aminopropyl acrylate; aminopropyl methacrylate; aminoisopropyl acrylate; aminoisopropyl methacrylate; aminobutyl acrylate; aminobutyl methacrylate; aminohexyl acrylate; amimohexyl methacrylate; aminooctadecyl methacrylate; aminooctadecyl acrylate; aminolauryl methacrylate; aminolauryl acrylate; N,N-dimethylaminoethyl acrylate; N,N-dimethylaminoethyl methacrylate; N,N-diethylaminoethyl acrylate; N,N-diethylaminoethyl methacrylate; piperidino—N-ethyl acrylate; vinyl propionate; vinyl acetate; vinyl butyrate; vinyl butyl ether; and vinyl propyl ether, among others. The raw materials of liquid nano carbon are selected from variety sources including natural coal products such as mud coals embedded in the rice field, fossil coals or charcoal from oil wells, coal tar and man made coals product from oxygen free burning process of coconut, pine wood, wood. The raw materials can also be obtained from burning process of kerosene oil, diesel, rubber, unsaturated natural gas. The commercially available carbon black products from Cabot, Degussa are also useful for the exemplary test of the present invention. The bulky block coal products need to be pulverized into powdery products using certain kinds of mechanical grinding mechanism including high speed attritor. The powdery coals, then, are purified with hot water without and with acidic or base additives to remove mineral impurities. The organic impurities are removed off the raw materials with organic solvents following the basic steps of organic chemical experiments. Electrolytic solvents are strong polar solvents which can provoke the ionization of the electrolytic groups attached onto the liquid nano carbon. Electrolytic solvents can also form a dipole momentum with electrolytic chemical groups onto the surface of “liquid “nano carbon. The example of electrolytic solvents are water, alcohols and polyols such as but not limited to butanol, butanediol, butanetriol, phenol, among others), ketones, halogenated solvents, pyrrolidones, morpholines, quinolines, acetic acid, among others. Electrolytic additives are basically acidic or alkaline/basic functional molecules including low molecular weight compounds and high molecular weight polymers. The examples of electrolytic additives are but not limited to NaOH, KOH, Zn (OH) 2, Mg (OH) 2, NH4OH, NaHCO3, NaHSO3, MeONa, MeOK, EtONa, EtOK, aminotoluene sulfonic acid, 2-amino-1-propanol, and the likes. Dependent upon the final applications, the liquid nano carbon can be used alone in electrolytic solvents with and without electrolytic additives or it can be used with polymer. The suitable polymers for thermo sensitive recording media with high energy source print heads( e-beam, laser beam, X-Ray, thermal print heads, among others) are heat induced hydrogen bonding formers such as but not limited to egg albumin, heat induced hydrogen bonding deformers such as but not limited to gelatin, oceanic protein and the likes, heat induced degradation such as but not limited to polymethylmethacrylate (PMMA), polyimides, among others.

The following examples provide more details on the process of making liquid nano carbons:

### EXAMPLE 1

### Preparation of Coal Raw Material A

100 g of dried coconut fruit was inserted into nitrogen filled furnace (made by University of Technologies in Ho Chi Minh City, Vietnam). The temperature was set at 600 C and the dried coconut was burned off within 10 minutes after the set temperature was reached. The black smoke, a product of burn process of dried coconut, is quickly removed by nitrogen gas flow to water quenching station and then to receiving station, yields 56% of black powder at the receiver. The coconut coal product was stirred in 90 C hot mixture of water added with 10% KOH and NMP (ratio 8:2) for 3 hrs, then, filtered and dried at 90 C for 1 hr. The product, then, was coated with Pt/Mo using sol gel process. In this process, 70 g coconut coal product was mixed with 0.01 g platinum (II) acetylacetonate (Aldrich Chemicals, Cat 28,278-2) and 1 g of Molybdenum acetylacetonate (Aldrich Chem., Cat, 22,774-9) in 100 ml acetone by magnetic stirrer at room temperature for 1 hr. The heat from magnetic stirrer was slowly raised up to 50 C and kept the same for another 1 hr until all of solvents is gone. 50 g of Pt/Mo coated coconut coal product was then soaked in 100 ml of mixture of water/methanol (ratio 4/6) for 1 hr, rinsed and then quickly transferred into an oven already set at 650 C and let sit for 15 minutes with quick nitrogen purge follwed with a steam water spray at the end. A fine powdery black particle was obtained as a raw material (A) ready for next step of preparing liquid nano carbon.

### EXAMPLE 2

### Preparation of Raw Material B

Repeat example 1 except that 10 gr of carbon black from Degussa NIPex® 60 was used instead of coconut coals. The raw material powder, first, was placed in the plasma chamber of a sputter (JEOL SEM, Japan) to receive Pt plasma bombardement at 40 mA for 30 sec. The Pt plasma is followed with uniform mixing of powder after every bombardement and the Pt sputtering was repeated 4 times. Afterwards, the Pt doped carbon black product was baked at 600 C following the procedure described in example 1, to give rise to raw material B

### EXAMPLE 3

### Preparation of Raw Material C

100 gr of carbon black product Carbojet 200 from Cabot Corporation (15% solid in water) was hot stirred on a heated magnetic stirrer until all of water evaporated. The chunk black product was then manually pulverized with a modal pestal to achieve black powder. The heat pre-treatment was done by repeating the process described in example 2, to achieve a raw material C.

### EXAMPLE 4

### Preparation of Liquid Nano Carbon From Raw Material A

The following operations were performed:
a) 5 g of 2-aminoethanesulfonic acid (Aldrich product, Cat number 15,224-2) was completely dissolved in a 100 ml glass beaker containing 10 g of mix solvents of water and NMP (ratio 4:1).
b) 10 g of raw material (A) prepared in the example 1 was added in with stirring until a uniform mixture is achieved.
c) The mixture was heated up to 80 C and maintained at the same temperature for 20 minutes.
d) Next 5 g of NaNO₂ was dissolved in 5 g distilled water and was drop-wise added into the mixture maintained at 80 C for further 30 minutes and stirred until the black and thick slurry became thinner liquid.
e) The stir is continued until most of water is gone. The product was further dried at 270 C for another 10 minutes.

The process from (a) to (e) was repeated on the same pigment at least for 5 times to obtain a product named as liquid nano carbon (A1). The product (A1) was turned into a mixture of water and isopropanol (IPA) (ratio 4:1), then stirred until a uniform slurry is achieved, then, added with 1% of 3-Amino-1-propanol (Aldrich product, Cat A7,640-0) while stirring. The mixture was spin coated onto the surface of a Si wafer having 4″ diameter mounted on a spinning chuck of a spinner (Solitec Company). The spin coating was done at 30 sec for 4000 rpm to achieve a uniform film of liquid carbon product from coconut coal, having thickness of 400Ao after being baked on a hot plate set at 110 C for 1 minute.

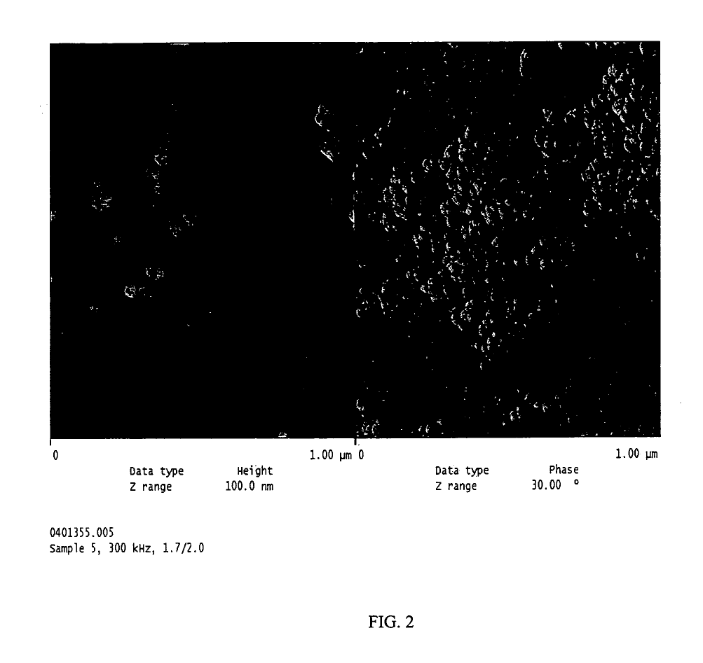

The liquid nano carbon film was observed with Atomic Force Microscopy (Veeco equipment) and an image of the liquid nano carbon film is reproduced in FIG. 2. As shown therein, the AFM image of spin coated liquid nano carbon particles from coconut coal has an average particle size between 20-30 nm.

In another variation, example 4 was repeated with pure water was used instead of the water/IPA mixture and without additive 3-Amino-1-propanol.

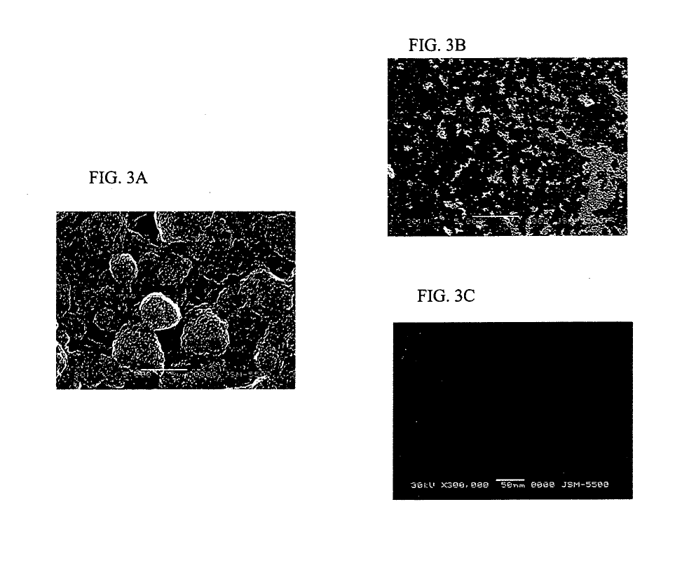

FIGS. 3A-3C shows various AFM (Atomic Force Microscopy) images of liquid nano-carbon particles for comparison purposes. The average particle size of individual particle was detected to be in the range between 20-30 nm. FIG. 3A shows the raw material (carbon black) at a 5000× magnification using Scanning Electron Microscope (SEM). FIG. 3B shows liquid nano carbon particles electrolytically separated by water at a 5000× magnification. FIG. 3C shows liquid nano carbon particles electrolytically separated by water and a base at a 300,000× magnification.

Viewing FIGS. 3A-3C together, a particle size comparison can be made among raw materials (coconut coal); liquid nano carbon product dispersed in water; and liquid nano carbon product dispersed in water added with electrolytic solvent (IPA) and electrolytic additive (3-Amino-1-propanol). The liquid nano carbon particles of FIG. 2C gives rise to a small particle size with no grain boundary as shown in the SEM images even though the particles of FIG. 2C were viewed at a 300,000× magnification whereas the particles of FIGS. 2A-2B were shown at a 5000× magnification.

### EXAMPLE 5

### Preparation of Liquid Nano Carbon From Raw Material B

In this example, the operations of Example 4 are repeated, but the raw material A is replaced with the raw material B of Example 2.

The result is liquid nano carbons B1 having an average particle size between 20-30 nm as measured by AFM.

### EXAMPLE 6

### Preparation of Liquid Nano Carbon From Raw Material C

In this example, the operations of Example 4 are repeated, but the raw material A is replaced by the raw material C of Example 3. The result is liquid nano carbon C1 having average particle size of also between 20-30 nm, as confirmed by AFM.

### EXAMPLE 7

### Micropatterning of Liquid Nano Carbon Particles

In one embodiment, the micropatterning process included:
a) spin 4 “Si wafer with adhesion promoter HMDS (Shin Etsu Chemical product), 4000 rpm, 30 sec
b) spin liquid nano carbon of example 3 onto it with the same speed and time
c) Dried wafer on the hot plate set at 110 C for 1 minute then cooled it down
d) Spin positive photoresist AZ9200 (Clariant product) with speed 3000 rpm for 60 sec then baked wafer in the oven set at 90 C for 30 minutes then cooled it off for 1 hrs
e) Exposed the photo resist layer with Canon mask aligner using proximity mode for 90 sec at the light intensity of 10 mW/cm2
f) Develop the exposed image with developer AZ400 (Clariant) for 30 sec to achieve micro patterning image
g) Spin dry the image
h) Soak the wafer in the acetone to remove the resist, leaving the micro patterned image of liquid nano carbon.

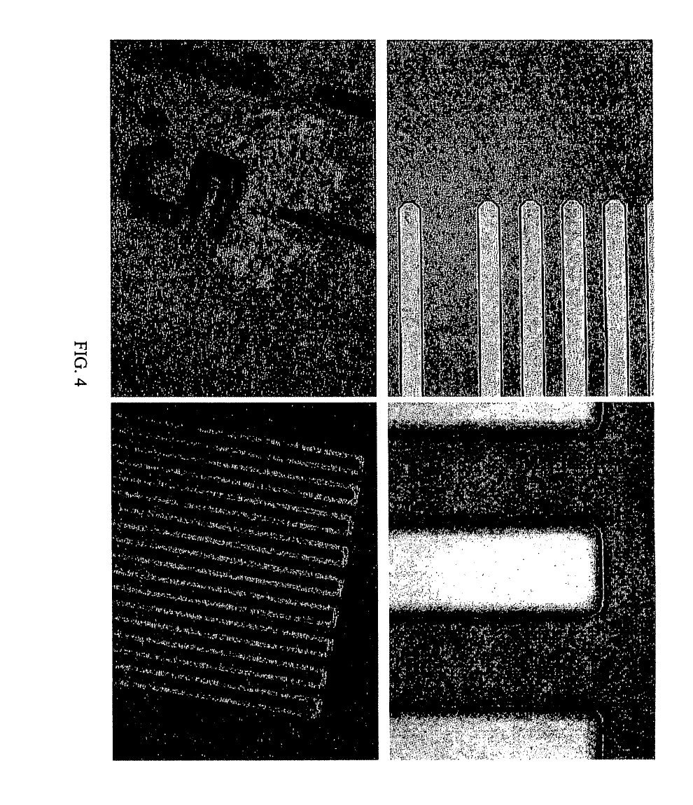

The picture of micro patterning of liquid nano carbon is illustrated in FIG. 4, showing line width of 1.5 microns. FIG. 4 exhibits micropatterns on the liquid nano carbon film using positive photo resist. As shown therein, micro-patterns can be formed with precision using the liquid nano-carbon film. For example, the pictures of micro patterns of liquid nano carbon particles are illustrated in FIG. 4 showing line widths of 1.5 microns.

### EXAMPLE 8

### Preparation of Liquid Toner With Liquid Nano Carbon

a) Preparation of Charged Particle

100 gr of Cabojet 300 (Cabot Corp) was dried out to obtain 15 g solid (raw material D)

Repeat example 4 except that 2-aminoethanesulfonic acid (Aldrich product, Cat number 15,224-2) was replaced with 12-Aminododecanoic acid (Aldrich Chemicals, Cat 15,924-7), to obtain liquid nano carbon having two anchor groups; —COOH from Cabot product and -dodecanoic acid from the new coupling (charged particle D2).

b) Preparation of Liquid Toner

10 g of D2 product was milled in 100 g IsoparG (Exxon Product) stainless steel beads (2 mm diameter) using a roll miller for 72 hrs.

400 g of in-house emulsion copolymer (styrene acrylate, 25% solid in IsoparG) was added into the above dispersion and the mill was continued for another 24 hrs, to obtain a liquid toner without using charge control agent. The toner was tested with Ricoh copy machine SFT60 using liquid toner and achieved high contrast image.

### EXAMPLE 9

### Preparation of Dry Toner With Liquid Nano Carbon

15 g of D2 product obtained from example 8 was redispersed in 400 g aqueous emulsion copolymer styrene/acrylate (Joncryl 77, Johnson & Johnson) using a ball mill with ceramic beads having diameter size of 3 mm, for 72 hours. The mixture was isolated from ceramic beads and drop wise into a beaker containing ethanol cooled by an ice bath placed above a magnetic stirrer with strong stirring power until particle can be observed. The particles were isolated by filtering and dried at 35 C for 10 hours. Next the 100 g of dried particle was refilled with 100 g of fumed silica (Cabot product, CAB-O-SIL) using steel stainless beads (3 mm diameter) under warm (40 C) water jacket. This yielded dry particles having surface charge of 34 Coulomb/g. The product was tested with Laserjet printer (HP Laserjet 1300) yielding high contrast white and black print-outs.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (Asics) or suitably programmed field programmable gate arrays (FPGAs).

From the a foregoing disclosure and certain variations and modifications already disclosed therein for purposes of illustration, it will be evident to one skilled in the relevant art that the present invention can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

What is claimed is:

1. A fabricated particle, comprising:
a liquid nano carbon having individual particles with an average size below 30 nanometers, each particle comprised of a solid carbon based core and a shell made with one or more anchor groups chemically attached to the shell.

2. The particle of claim 1, wherein the nano carbon comprises carbon black.

3. The particle of claim 1, wherein the nano carbon comprises fullerene.

4. The particle of claim 3, wherein the nano carbon comprises one of C-60 and C-70.

5. The particle of claim 1, wherein the nano carbon comprises carbon nano tube.

6. The particle of claim 1, wherein the nano carbon is chemically attached with at least one of hydrophilic chemical groups and lipophilic chemical groups.

7. A method of fabricating a nano particle, comprising:
increasing a density of electrolytic functional groups on a carbon black; and
exposing the carbon black in a strongly electrolytic environment.

8. The method of claim 7, comprising baking a carbon raw material between approximately 600 C-1000 C.

9. The method of claim 8, comprising water quenching the carbon raw material prior to chemical attachment of electrolytic functional groups.

10. The method of claim 9, comprising providing one or more hydrophilic chemical groups with one or more water soluble ionic groups.

11. The method of claim 7, comprising providing one or more lipophilic chemical groups.

12. The method of claim 11, wherein the chemical groups comprise organic solvent soluble chemical functional groups.

13. The method of claim 12, wherein the functional group comprises one of: alkyl, alkenes, phenyl alkyl, aryl, aryl alkyl, perfluoroalkyl, cyclobutane, siloxane, —SiH, —SiCH═CH2, with and without —OH, —SH, —COOH, —COOR, —CO, —CHO, —NO2, —NR1R2, —OR, —SR, —CN, —SO2, and halogen (—Cl, —I, —Br, —F), wherein R, R1, R2═H, alkyl, alkenes, phenyl alkyl, aryl, aryl alkyl, perfluoroalkyl, cyclobutane, siloxane, —SiH, —SiCH═CH2.

14. The particle of claim 1, wherein the liquid nano carbon is used in one of: dip pen lithography, x-ray lithography, e-beam lithography, nanoimprinting, and nano patterning.

15. The particle of claim 1, wherein the liquid nano carbon comprises an ink.

16. The particle of claim 14, wherein the ink is used for nanolithography.

17. The particle of claim 14, wherein the ink is used in one of digital and analog printing processes.

18. The particle of claim 14, wherein the ink is used as one of a dry toner and a liquid toner for electro photographic printing apparatus.

19. The particle of claim 14, wherein the ink is used as drop on demand ink.

20. The particle of claim 14, wherein the ink is used as a continuous ink for thermal inkjet print head and piezoelectric inkjet print head.

21. The particle of claim 14, wherein the ink is used as inking material for thermography including one of direct thermal printing and thermal transfer printing.

22. The particle of claim 14, wherein the ink is printed on one of: semiconductor wafer, insulator, insulating wafer, plastic, metal, polymer, plain paper and coated paper.

23. The particle of claim 1, wherein liquid nano carbon is used alone or with a polymer, a low molecular weight additive, a pigment colorant, a dye colorant, a charge control agent, and an ion charge neutralizer.

24. The particle of claim 1, wherein the liquid nano carbon forms micropatterns in combination with a photoresist for photolithography.

25. A process of making liquid nano carbon, comprising:
pretreating a carbon powder with heat;
attaching one or more electrolytic chemical groups onto the surface of the pretreated carbon powder; and
isolating nano particles in an electrolytic environment.

26. An anchor group formed by:
a. doping a surface of a raw material with a metal transition catalyst;
b. soaking the catalyst doped raw material in a proton source and/or a hydroxyl source agent having a carbon based core;
c. baking the carbon based core at 600 C-1000 C followed by quick water quenching prior to chemical attachment of the anchor group; and
d. attaching the anchor group onto the surface of the carbon based core to form a shell, wherein the anchor groups forming the shell of the carbon based core comprise electrolytic chemical groups which can form charge for the liquid nano carbon in an electrolytic environment.

27. The anchor group of claim 26, comprising water soluble ionic groups.

28. The anchor group of claim 26, comprising water soluble ionic groups and non ionic groups.

29. The anchor group of claim 26, comprising organic solvent soluble chemical functional groups comprising one of: alkyl, alkenes, phenyl alkyl, aryl, aryl alkyl, perfluoroalkyl, cyclobutane, siloxane, —SiH, —SiCH═CH2, with and without —OH, —SH, —COOH, —COOR, —CO, —CHO, —NO2, —NR1R2, —OR, —SR, —CN, —SO2, halogen (—Cl, —I, —Br, —F), in which R, R1, R2═H, alkyl, alkenes, phenyl alkyl, aryl, aryl alkyl, perfluoroalkyl, cyclobutane, siloxane, —SiH, and —SiCH═CH2.
